(19) United States
(12) Patent Application Publication
(10) Pub. No.: US 2006/0251197 A1
(43) Pub. Date: Nov. 9, 2006

(54) Multiple coefficient filter banks for digital audio processing

(75) Inventors: David Edward Zaucha, Carrollton, TX (US); Douglas Allen Roberson, Rockwall, TX (US); Josey George Angilivelil, Sachse, TX (US); Lars Risbo, Kobernhavn (DK)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/120,724

(22) Filed: May 3, 2005

(51) Int. Cl. H04B 1/10

(52) U.S. Cl. 375/350

(57) ABSTRACT

A digital audio processor (20) is disclosed, in which digital filter coefficients associated with a plurality of sampling frequencies are stored in a plurality of coefficient memory banks (55). A controller in the digital audio processor (20) selects one of the coefficient memory banks (55) for use in the digital signal processing channels (44). In a manual mode, this selection is in response to a manual selection entry in a bank control register (41). In an automatic mode, indicated by a specific entry in the bank control register (41), sample rate detector circuitry (54) detects the sampling frequency relative to an external reference, such as a crystal (XTL); the appropriate one of the coefficient memory banks (55) is then selected based on sampling frequency associations stored in rate select register (43) in the controller (40).

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of digital signal processing, and is more specifically directed to digital signal processing in digital audio systems, such as digital receivers, that support multiple audio sources.

In recent years, digital signal processing techniques have become prevalent in many electronic systems. Tremendous increases in the switching speed of digital circuits have enabled digital signal processing to replace, in large part, analog circuits in many applications. For example, the sampling rates of modern digital signal processing are sufficiently fast that digital techniques have become widely implemented in audio electronic applications. These digital audio signal processing techniques now extend even to the driving of the audio output amplifiers.

As a result of these advances in digital audio amplifiers, and advances in digital signal processing generally, audio-visual receivers can now be realized nearly entirely in the digital domain. To the extent that audio signals remain to be processed, these digital receivers can convert any received analog audio input signals to digital form, and process the corresponding signals in a similar manner as the other digital audio signals in the system.

Modern digital audio-visual receivers and digital audio receivers are typically required to be capable of receiving audio input from a wide variety of sources. For example, a typical digital audio amplifier can receive, process, and amplify audio signals from an AM/FM radio tuner (which may be built into the receiver), analog line-in inputs to receive analog audio from an external source, optical or other digital line-in inputs to receive audio signal from a satellite or cable television source, digital audio signals from a CD player, and still other sources. Because these digital receivers process the audio signals in the digital domain, the incoming audio signals must be either received in digital form, or converted from analog signals to digital signals. In either case, the resulting digital representation of the audio signals to be processed is in the form of a datastream of digital words (typically sixteen, twenty, or twenty-four bits in width), each digital word having a value corresponding to the amplitude of a sample of the audio signal at a sample point in time. Inherently, therefore, the digital audio signal datastreams are at a sampling frequency, which is the rate at which the digital samples are applied at the input to the digital audio signal processing circuitry.

As is well known in the art, these multiple digital audio signal sources generate digital output at different sampling frequencies relative to one another. Common digital audio sampling rates are 32 kHz, 44.1 kHz, and 48 kHz. For example, CD players and MP3 players typically generate 44.1 kHz datastreams, while DVD players typically generate digital audio at the 48 kHz sampling frequency. And higher-performance digital recordings at a sampling frequency of 96 kHz are now also being produced. Accordingly, modern digital audio receivers, and digital audio-visual receivers, must have the capability of handling digital audio signal datastreams at multiple sampling frequencies.

In addition, in digital audio receivers that drive so-called “class D” digital outputs, it is known that the frame rate of the pulse-width-modulated class D output switching can cause interference with AM tuner reception; specifically, this PWM frame rate can interfere with the AM tuned frequency itself, with intermediate frequencies generated in AM demodulation, or in image frequencies resulting from AM demodulation. For digital audio receivers that generate the PWM frame rate at a frequency multiple of the input sampling frequency, it is known that this AM interference from the PWM frame rate can be avoided by changing the sampling frequency of the digital audio signal for different AM tuned frequencies, to keep the PWM frame rate and its harmonics at frequencies away from the frequencies involved in AM demodulation.

However, the parameter of sampling frequency is an important parameter in many digital signal processing operations for audio applications. As is fundamental in the digital audio processing art, the infinite impulse response (IIR) digital filter is an important type of digital filter that is commonly used in audio processing. The second order IIR digital filter, commonly referred to as a “biquad”, is a popular IIR building block, and can be cascaded to provide very high order digital filter functions at low cost and high efficiency. For example, conventional digital audio processing devices, such as the TAS3103 digital audio processor available from Texas Instruments Incorporated, include on the order of twelve biquad IIR filters per audio channel to provide graphic equalization, speaker parameter equalization, phase compensation, and the like; additional biquads are used in bass and treble control, and other audio functions.

Biquads can be readily executed by programmable circuitry, such as a digital signal processor (DSP), or by a custom hardware architecture. For example, U.S. Patent Application Publication US 2005/0076073, entitled “Biquad Digital Filter Operating at Maximum Efficiency”, assigned to Texas Instruments Incorporated, provides an excellent description of a biquad architecture, for use in digital audio signal processing.

By way of background, FIG. 1 schematically illustrates the direct form of a conventional biquad, second order IIR digital filter 10. Input datastream x{n} is a sequence of discrete input values, which are processed by filter 10 to produce output datastream y{n}, also as a sequence of discrete values. The filter equation implemented by filter 10 of FIG. 1 can be expressed as:
y(n)=b0·x(n)+b1·x(n−1)+b2·x(n−2)+a1·y(n−1)+a2·y(n−2)
where the sample indices n−1, n-2 refer to previous values of the input and output datastreams. Referring to FIG. 1, the feed-forward side of digital filter 10 is implemented by multiplier 2₀for multiplying current input value x(n) by coefficient b0, multiplier 2₁ for multiplying the next previous input value x(n−1) from delay stage 3₀ by coefficient b1, and multiplier 2₂ for multiplying twice-delayed input value x(n−2) from delay stage 3₁ by coefficient b2. On the feedback side, multiplier 4₀ multiplies the previous (once-delayed) output value y(n−1) from delay stage 5₀ by coefficient a1, and multiplier 4₁ multiplies twice-delayed previous output value y(n−2) from delay stage 5₁ by coefficient a2. The outputs of multipliers 2 and 4 are all applied to inputs of adder (or accumulator) 6, and the resulting sum from adder 6 constitutes the current output sample value y(n), after clipping by limiter 7. This direct-form representation is typical for second-order IIR digital filters, as is fundamental in the art.

As is also fundamental in the art, the desired frequency response characteristics of the biquad filter is determined by the values of the coefficients a0, a1, a2, b0, b1, b2; indeed, the frequency response characteristics of any digital filter, of either IIR or FIR form, is determined by its coefficient values. Conversely, the shape of the desired particular frequency response, such as low-pass, high-pass, band-pass, notch, and the like, and the characteristic frequency f₀ (i.e., the center, corner, midpoint, or other frequency of interest) of the filter, determine the values of these filter coefficients. However, as is also well known in the art, these filter coefficients do not depend only on the characteristic frequency f₀ in the absolute, but instead typically depend on a ratio of the characteristic frequency f₀ to the sampling frequency fₛ of the datastream.

In practice, the frequency response characteristics, including the characteristic frequency f₀, of the digital filters applied in digital audio processing correspond to the desired audio output signal (e.g., in graphic equalization, treble and bass control, etc.), as either selected by the human listener or by the system designer. In other words, the desired frequency response of the digital filter is independent of the sampling frequency. But, as mentioned above, different audio signal sources present digital audio signals at different sampling frequencies; in addition, also as mentioned above, the sampling frequency fₛ may be adjusted to avoid interference effects. The frequency response and characteristic frequency f₀ of the digital filters are independent of sampling frequency, and therefore do not change if the sampling frequency fₛ is changed. Because the characteristic frequency f₀ remains fixed, the values of the filter coefficients a1, a2, b0, b1, b2, etc. must therefore be changed if the sampling frequency fₛ changes.

It has been observed, in conventional digital audio receivers, that the changing of filter coefficients with a change in sampling frequency fₛ is a cumbersome operation. FIG. 2 illustrates the architecture of a conventional digital audio receiver, to illustrate this problem. In the conventional system of FIG. 2, input multiplexer 11 receives digital audio signals from each of multiple audio sources (not shown), and selects one of these signals for forwarding to digital audio processor 13, under the control of a select signal from system controller 15. Typically, system controller 15 receives user inputs that indicate the particular audio source to be selected. Multiplexer 11 then forwards a datastream, at the sampling frequency generated by the corresponding audio source, to digital audio processor 13 on bus DIG_AUD.

Digital audio processor 13 is a conventional integrated circuit for processing the selected audio signal by applying digital filters for equalization and other purposes, as discussed above, as well for performing other processing such as input and output crossbar mixing and switching, applying 3D effects, and the like. An example of conventional digital audio processor 13 is the TAS3103 digital audio processor mentioned above. Digital audio processor 13 applies its output as pulse-code-modulated (PCM) digital signals, one per channel, to audio amplifier 15. Audio amplifier 15 amplifies and formats the PCM audio signals into signals that drive power stages 17₁ through 17₄, each associated with one of the audio channels. Power stages 17₁ through 17₄ in turn drive speakers SPKR_1 through SPKR_4. In modern digital audio systems, audio amplifier 15 is a digital audio amplifier, and as such may also include additional digital filtering functions, as well as a pulse-width modulator to generate pulse-width-modulated control signals for application to power stages 17, driving speakers SPKR in a class D fashion.

In the conventional system of FIG. 2, system microcontroller 15 is in a separate integrated circuit from digital audio processor 13, and as such provides digital audio processor 13 with control signals and control information, including pre-calculated filter coefficients, for use in its digital signal processing functions. As mentioned above, system microcontroller 15 also controls the selection of the audio source via input multiplexer 11. In the event that a different audio source is selected by system microcontroller 15, for example in response to a user input, and that this different audio source presents digital data at a different sampling frequency fₛ from that of the previous audio source, the filter coefficients used by digital audio processor 13 must change accordingly, as discussed above. In conventional audio systems using conventional digital audio processors 13, however, these filter coefficients must be communicated to digital audio processor 13, for example by system microcontroller 15 over control bus CTRL_BUS. This downloading of filter coefficients to digital audio processor 13 is a relatively slow and cumbersome process, especially over conventional control bus architectures such as the I²C control channel used by the TAS3103 digital audio processor.

### BRIEF SUMMARY OF THE INVENTION

It is therefore an object of this invention to provide a digital signal processor that can efficiently process input signals at various sampling rates.

It is a further object of this invention to provide such a processor that is especially well-suited for digital audio processing.

Other objects and advantages of this invention will be apparent to those of ordinary skill in the art having reference to the following specification together with its drawings.

The present invention may be implemented into a digital signal processor, such as a digital audio processor or the like, that applies digital filters and performs other digital signal processing on digital data received at one of multiple sampling frequencies. The processor includes memory banks, each of which stores a set of digital filter coefficients for an associated one of the multiple sampling frequencies at which the input data is being received. The memory banks are accessible by the circuitry, in the processor, that executes the digital filters, or other functions utilizing coefficients that have values dependent on the sampling frequency. Preferably, circuitry is provided that automatically detects the sampling frequency of the input signal. The associated memory bank associated with the sampling frequency of the input signal is then selected to provide the filter coefficients and other parameters to the processing circuitry.

### BRIEF DESCRIPTION OF THE SEVERAL VIEWS OF THE DRAWING

FIG. 1 is a direct-form diagram illustrating a conventional biquad, or second-order infinite impulse response (IIR), digital filter.

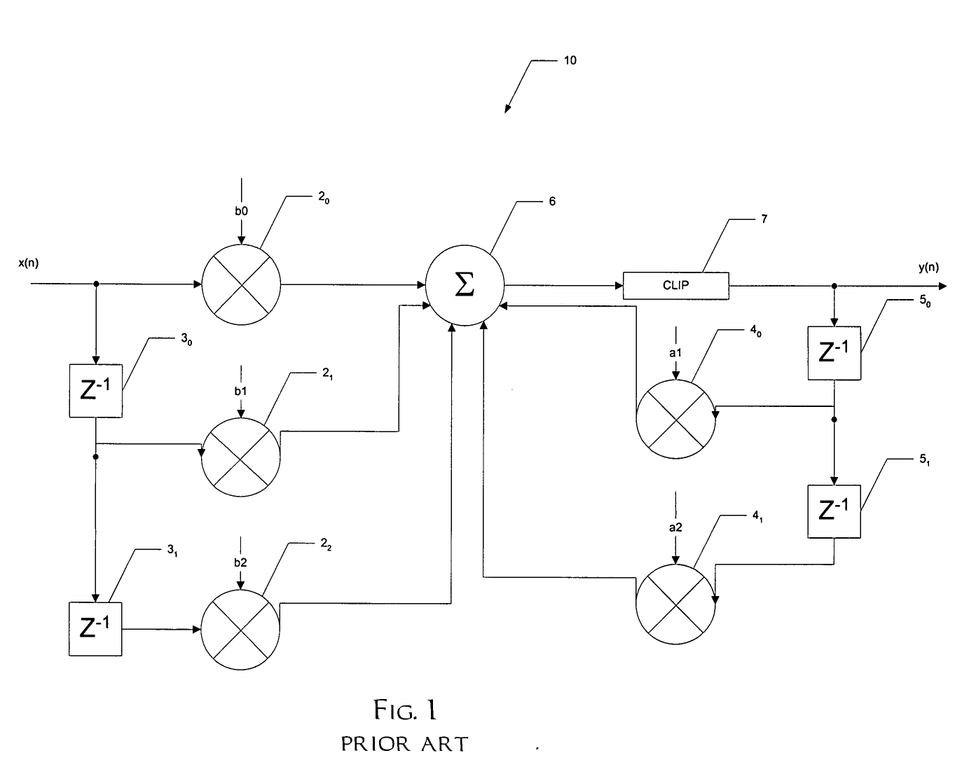

FIG. 2 is an electrical diagram, in block form, of a conventional digital audio receiver.

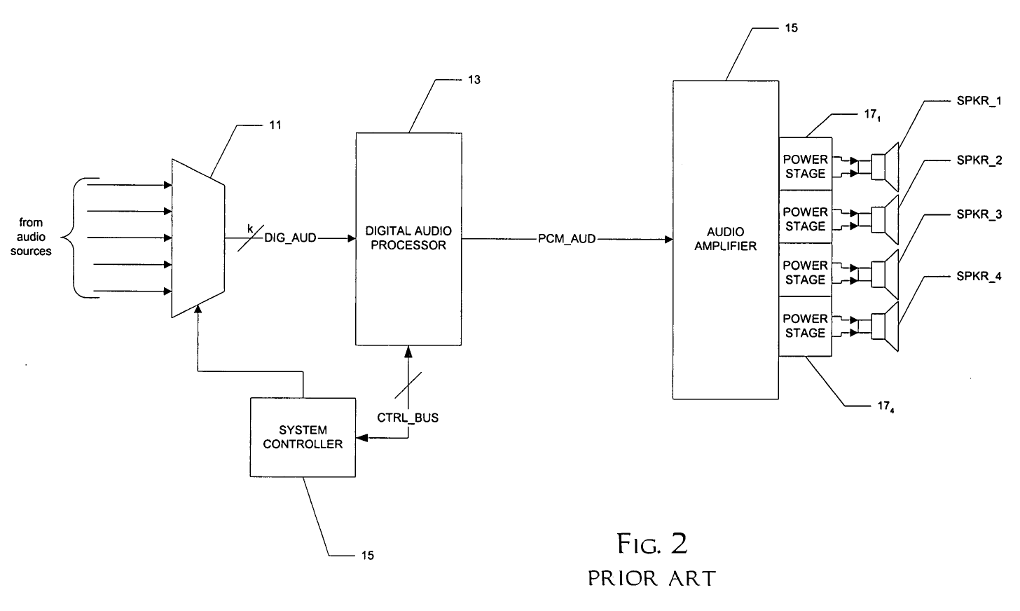

FIG. 3 is an electrical diagram, in block form, of a digital audio receiver constructed according to the preferred embodiment of the invention.

FIG. 4 is an electrical diagram, in block form, of a digital audio processor in the system of FIG. 3, and constructed according to the preferred embodiment of the invention.

FIG. 5 is a flow diagram illustrating the operation of the digital audio processor of FIG. 4 in initializing digital filter coefficients, according to the preferred embodiment of the invention.

FIGS. 6a and 6b are representations of the contents of registers in the digital audio processor of FIG. 4, according to the preferred embodiment of the invention.

FIG. 7 is a flow diagram illustrating the operation of the digital audio processor of FIG. 4 in changing the current digital filter coefficients in response to a change in the sampling frequency, according to the preferred embodiment of the invention.

### DETAILED DESCRIPTION OF THE INVENTION

The present invention will be described in connection with its preferred embodiment, namely as implemented into a digital audio receiver, as it is contemplated that this invention will be especially beneficial in such an application. It is further contemplated, however, that this invention may prove advantageous in many other digital signal processing applications in which the sampling frequency of the input digital signal can change. Accordingly, it is to be understood that the following description is provided by way of example only, and is not intended to limit the true scope of this invention as claimed.

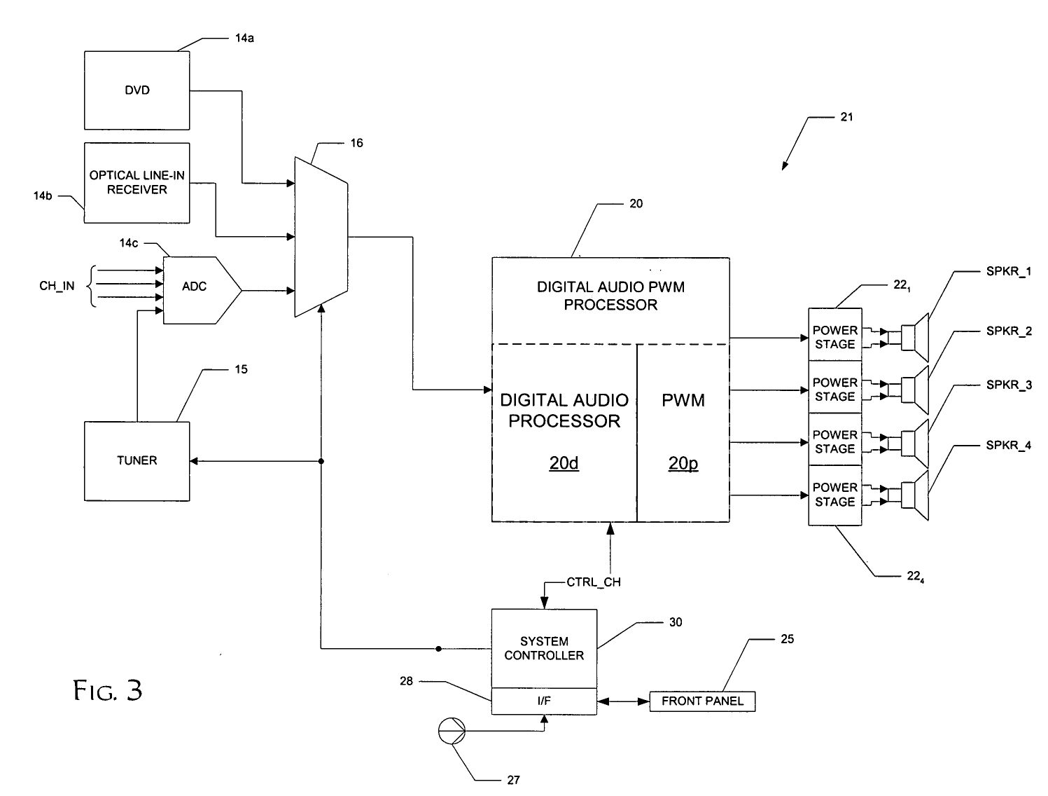

Referring now to FIG. 3, the construction of audio processing circuitry in digital audio-visual receiver 21 according to the preferred embodiment of the invention will now be described. The video data paths in digital audio-visual receiver 21 are not shown, for the sake of clarity in this description. In the example of receiver 21, multiple sources of audio signals are available to receiver 21, and may be processed into output audio by digital audio decoder and processor 12. Multiplexer 16 receives digital audio from DVD controller 14a, such audio corresponding to audio content from DVD movies, or audio contents from a CD, either being played on a DVD player (not shown) to which receiver 21 is connected. Optical line-in receiver 14b provides digital audio, for example from satellite or cable television sources, to another input of multiplexer 16. Analog-to-digital converter (ADC) 14c converts analog stereo signals from analog line-in inputs CH_IN and from tuner 15 to a digital datastream, and provides this datastream to another input of multiplexer 16. Multiplexer 16 chooses from among these inputs, and inputs from other sources if available, for application to digital audio PWM processor 20, under the control of system controller 30. The selection of audio source effected by multiplexer 16 is under user control; in this regard, system controller receives direct selection inputs from front panel switches 25 of receiver 21, or infrared remote control signals via infrared receiver 27, both communicating with system controller 30 via interface circuitry 28.

In a general sense, digital audio PWM processor 20 includes digital audio processing function 20d and pulse-width-modulation (PWM) function 20p. In general, digital audio processing function 20d digitally processes digital audio signals according to a sequence of functions including digital mixing, channel equalization, treble and bass control, soft volume, loudness compensation, dynamic range compensation, and the like. As mentioned above, and as will be described in further detail below, these digital audio processing operations are typically executed by way of digital filters. The output of digital audio processor 20d is forwarded to PWM function 20p, for example in the form of pulse-code-modulated (PCM) digital words. PWM function 20d converts the PCM digital audio signals at its inputs to corresponding pulse-width-modulated (PWM) output signals. In this example, PWM processor 20p produces, for each of the four supported channels, separate PWM control signals that are applied to a corresponding power stage 22₁ through 22₄, each of which drives a respective one of loudspeakers SPKR_1 through SPKR_4. Of course, more or fewer audio channels may be driven by receiver 21. In a simple stereo arrangement, only two channels may be processed; alternatively, as many as eight audio channels are now commonly handled by digital audio-visual receivers such as receiver 21. The number of channels supported and utilized by receiver 21 is a matter of choice for the designer and the user.

According to this embodiment of the invention, digital audio PWM processor 20, including both of the functions of digital audio processor 20d and PWM function 20p, along with the appropriate support controller and other circuitry, is preferably realized in a single integrated circuit. Alternatively, the two functions of digital audio processor 20d and PWM function 20p may be realized in separate integrated circuits from one another. In either case, it is contemplated that those skilled in the art, having reference to this specification including the detailed description of the construction and operation of digital audio PWM processor 20 provided below, will be able to realize this invention in a suitable manner for a specific application, without undue experimentation.

As mentioned above, system controller 30 provides audio source selection signals to multiplexer 16. In addition, system controller 30 provides channel volume control signals to PWM function 20p in digital audio PWM processor 20, and provides other control signals throughout receiver 21, including channel selection control to tuner 15 in response to user inputs received via front panel 25 or infrared receiver 27. According to the preferred embodiment of this invention, system controller 30 also provides multiple sets of digital filter coefficients to digital audio PWM processor 20, upon reset or power up of receiver 21 (or digital audio PWM processor 20 in receiver 21). These multiple sets of digital filter coefficients are stored in digital audio PWM processor 20, for use in applying digital filters to digital audio data of varying sample frequencies fₛ. In addition, control signals or data are provided by system controller 30 to digital audio PWM processor 20, over control channel CTRL_CH, to associate the multiple sets of coefficients with the appropriate sample frequencies, for manual switching among these coefficient sets, and to enable automatic switching, all as will be described in further detail below.

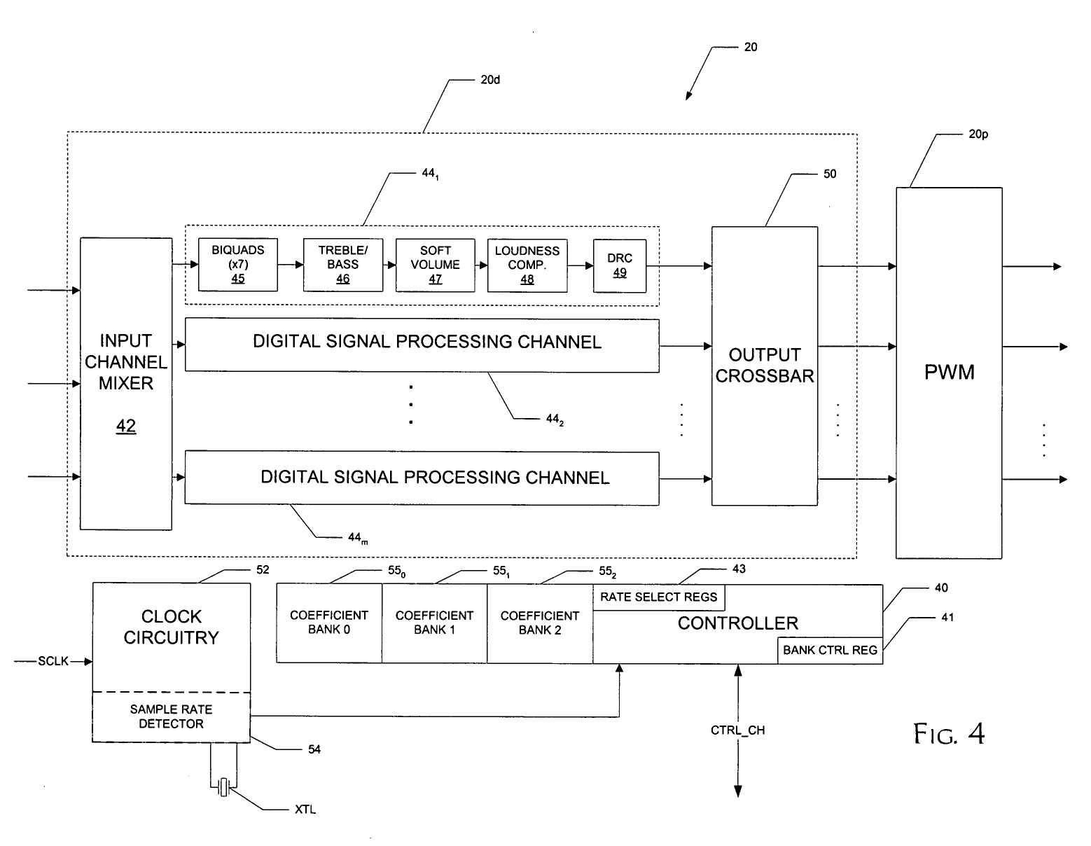

Referring now to FIG. 4, the construction of digital audio PWM processor 20, and of digital audio processor 20d therein, will now be described in further detail. Digital audio PWM processor 20 includes input channel mixer 42, which receives multiple incoming audio channels from input multiplexer 16 of FIG. 3. Mixer 42 is conventional circuitry for mixing each of the multiple input channels to a selected digital processing channel 44, under the control of controller 40; it is also contemplated that mixer 42 can provide other front-end functions, including multiplexing stereo channels to digital processing channels 44, applying 3D effects, and the like.

As shown in the example of FIG. 4, digital audio PWM processor 20 includes multiple digital signal processing channels 44, each for applying digital filters and other signal processing algorithms and functions to a single audio channel, or to time-multiplexed channels if desired. In this example, m digital signal processing channels 44₁ through 44ₘ are implemented, with the number m depending upon the desired capability of digital audio PWM processor 20, which may number from two or three, to as many as eight or more. Typically, the number of digital signal processing channels 44 that are implemented in digital audio processor 20p will correspond to the number of speaker channels to be driven by receiver 21, which in this example is four.

The construction of digital signal processing channel 44₁ will be described in detail, by way of example. It is contemplated that some or all of digital signal processing channels 44 are identically configured, although one or more of channels 44 may have special functionality, such as in the case of an extremely low bass channel for driving a sub-woofer, or in the case of a rear channel in a surround-sound system. According to this embodiment of the invention, biquad block 45 is first applied to the input digital audio signal from mixer 42. Biquad block 45 includes a series of biquad, second-order IIR, digital filters, executable in cascade. In this example, as many as seven biquad stages, implementing a digital filter of up to the fourteenth order, are implemented in cascade within biquad block 45. Biquad block 45 is useful for many audio processing functions, including such functions as parametric speaker equalization or “voicing”, implementation of graphic equalizer presets, and the like. Treble/bass function 46 receives the output of biquad block 45, and applies treble and bass adjustment as selected by the user or under program control, via controller 40. It is contemplated that treble/bass function 46 may also be implemented by cascaded biquads. The remainder of digital signal processing channel 44₁ includes soft volume block 47, which implements a precision soft volume control on the audio signal being processed for its channel. Loudness compensation block 48 applies a volume-dependent spectral shape on the audio signal, boosting bass frequencies when the output for the channel is low. Dynamic range compression (DRC) function 49 also shapes the spectrum of the output signal according to a linear frequency relationship, with the slope selected under user or program control via controller 40.

Additional signal processing functions, which are not shown in FIG. 4 for the sake of clarity, may also be implemented. These functions may implement digital audio features such as background noise floor compensation or noise squelch, center or sub-woofer channel synthesis, programmable dither, peak limiting and clipping, and the like. In addition, delay memory may also be implemented in the channel streams, to implement programmable delay in one or more of the channels.

It is contemplated that the signal processing functions of digital signal processing functions are preferably implemented as software routines executable by a digital signal processor (DSP) integrated circuit or core, having sufficient capability to execute the desired operations at the necessary data rate. In this implementation, program and data memory resources are provided either within the DSP integrated circuit, or external to and accessible by the DSP integrated circuit or core. It is contemplated that DSP circuitry such as described in U.S. Patent Application Publication US 2005/0076073, entitled “Biquad Digital Filter Operating at Maximum Efficiency”, assigned to Texas Instruments Incorporated, and incorporated herein by this reference, is an example of a suitable hardware architecture according to the preferred embodiment of the invention. Of course, custom or semi-custom logic circuitry may also be used to perform these operations within digital audio processor 20d.

Output crossbar 50 receives each of the digital output data streams from digital signal processing channels 44₁ through 44ₘ, and routes the processed channels to the desired inputs of PWM function 20ₚ in this example. Typically, the outputs of digital audio processor 30 are digital serial outputs, in PCM format as mentioned above. Output crossbar 50 thus permits programmable or user control of the assignment of channels to outputs, enabling a wide degree of freedom in the operation of the audio system.

Controller 40 in digital audio PWM processor 20 controls the operation of digital audio PWM processor 20 in response to predesigned control code and in response to user inputs. Controller 40 is preferably realized by way of programmable logic of a suitable architecture for executing these control functions and the particular functions described herein in connection with the preferred embodiment of the invention. The general control functions performed by controller 40 in controlling the operation of digital audio PWM processor 20 will not be described in detail, it being understood that those skilled in this art having reference to this specification will be readily able to implement such control functionality, without undue experimentation. In addition, clock circuitry 52 is also provided in digital audio PWM processor 20, to receive certain external clocks such as sample clock SCLK, a master high-speed clock (not shown), and other clocks used within receiver 21, and to generate the necessary clock signals for use internally to digital audio PWM processor 20 to effect its operations. It is therefore contemplated that clock circuitry 52 will include such clock circuit functions such as analog or digital phase-locked loops (or both), timer circuits, frequency dividers, and the like.

According to this embodiment of the invention, clock circuitry 52 also includes sample rate detector circuit 54, which detects the frequency of sample clock SCLK and thus the sampling frequency fₛ of the digital data received by digital audio PWM processor 20. In this example, sample rate detector circuit 54 includes a time base reference, for example a crystal oscillator, connected to external crystal XTL, for generating a reference frequency used in the detection of the frequency of sample clock SCLK. Those skilled in the art having reference to this specification will recognize alternative approaches to producing this time base reference time. External sources of periodic signals, such as any analog or digital circuitry capable of producing a periodic signal, may be used. The time reference may alternatively be produced internally to digital audio PWM processor 20 by way of analog or digital resonant circuitry such as a PLL or other periodic operating logic. Sample rate detector circuit 54 may be constructed to include a counter that counts cycles of sample clock SCLK relative to the reference clock based on external crystal XTL, and logic that generates output control signals to controller 40 based on the results of this relative counting, such control signals indicative of the frequency of sample clock SCLK relative to the reference clock.

It is contemplated that sample clock SCLK or a clock signal derived from sample clock SCLK will be provided to digital audio processor 20, considering that at least some of the operations of digital audio processor 20 must be carried out at sampling frequency fₛ. In the alternative, however, digital audio processor 20 may include circuitry for recovering a sample clock from the transitions of the incoming datastream itself, in which case an externally applied sample clock SCLK need not be applied to digital audio processor 20.

Also, according to this preferred embodiment of the invention, multiple coefficient memory banks 55 are provided, for storing sets of digital filter coefficients. In this example, three coefficient banks 55₀ through 55₂ are available in digital audio PWM processor 20. Each coefficient bank 55 contains sufficient memory for storing coefficient values for each of the digital filter functions within digital signal processing channels 44, for one or more sampling frequencies fₛ. For the example of digital audio processor 20d of FIG. 4, each bank will store digital filter coefficients sufficient to support four bass filter and four treble filter sets, thirty-five equalizer coefficients (five per biquad) for each channel, five loudness coefficients, two dynamic range compression values, four dynamic range compression “attack” and “decay” time values. As evident from this description, coefficient values that depend on sampling frequency fₛ include not only digital filter coefficients but also timer parameters such as used in dynamic range compression functions 49. As such, three sets of sample rate-dependent coefficients can be made available, for use by digital signal processing channels 44 under the control of controller 40.

Association of sample rates with coefficient banks 55₀ through 55₂, and the selection of the desired one of coefficient banks 55₀ through 55₂, is effected by controller 40 in various ways, according to the preferred embodiment of the invention. Controller 40 includes bank control register 41, by way of which selection of a manual or automatic bank switching mode can be selected, preferably by system microcontroller 30 writing a control word over I²C control channel CTRL_CH. For automatic bank switching operation, rate select registers 43 can be written by system microcontroller 30, also over I²C control channel CTRL_CH, with the desired association of selected ones of coefficient banks 55₀ through 55₂ with particular sampling frequencies fₛ. As mentioned above, controller 40 also effects the storing of coefficient values in coefficient banks 55₀ through 55₂ during power-up or reset, with the values being communicated from system microcontroller 30 over I²C control channel CTRL_CH. And as will be described below, these coefficient values in coefficient banks 55₀ through 55₂ can also be updated by system microcontroller 30 over I²C control channel CTRL_CH, after power-up and during operation.

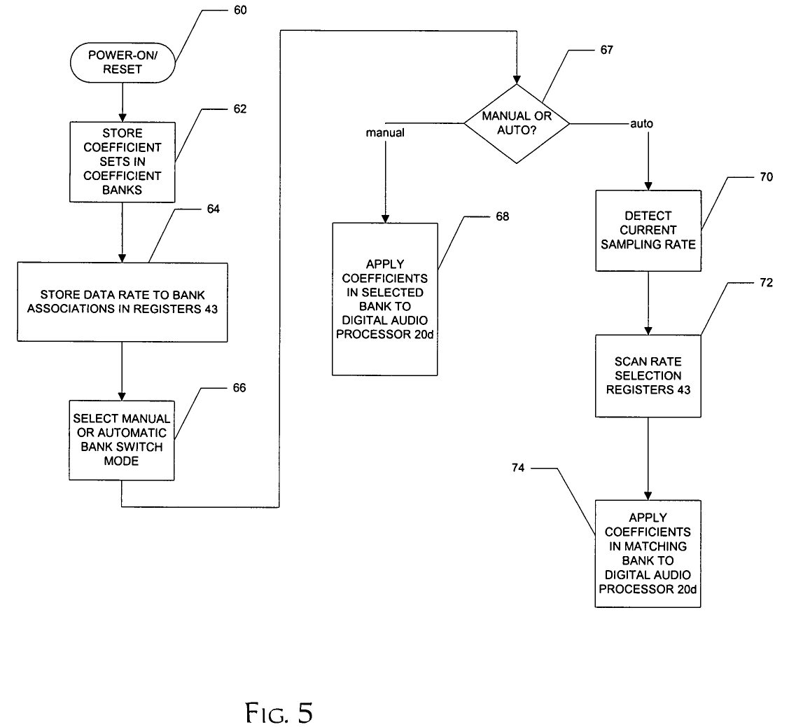

The operation of digital audio PWM processor 20 in utilizing the appropriate coefficient values, for digital filter and other coefficients that have values dependent on the sampling frequency fₛ, and according to the preferred embodiment of the invention, will now be described relative to FIG. 5, beginning with the initialization of the coefficient values, through operation of digital audio PWM processor 20.

Power-on and reset, or a powered reset, of digital audio PWM processor 20 occurs in process 50, and according to this embodiment of the invention, begins initialization of the coefficient values stored in coefficient banks 55₀ through 55₂. In process 52, therefore, system microcontroller 30 forwards the coefficient values for the multiple coefficient banks 55₀ through 55₂ to digital audio PWM processor 20 over I²C control channel CTRL_CH. In turn, controller 40 of digital audio PWM processor 20 stores these values in the addressed locations of coefficient banks 55₀ through 55₂. Because digital audio PWM processor 20 is powering up at this time and therefore time-critical operation has not yet begin, the time required for transmittal of these values over control channel CTRL_CH can be tolerated.

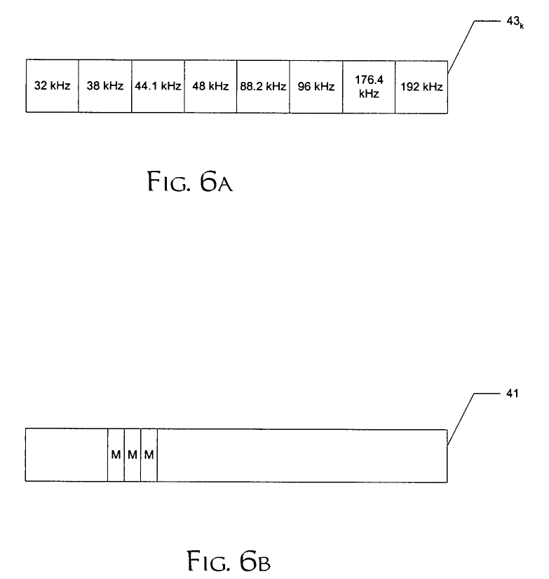

In process 64, system microcontroller 30 forwards data rate association information to digital audio PWM processor 20 over control channel CTRL_CH, for storage in bank select registers 43. FIG. 6a illustrates an exemplary bank select register 43ₖ to illustrate its arrangement. According to the preferred embodiment of the invention, bank select register 43ₖ includes a bit position for each of the supported sampling frequencies fₛ. In the example of FIG. 6a, these frequencies are 32 kHz, 38 kHz, 44.1 kHz, 48 kHz, 88.2 kHz, 96 kHz, 176.4 kHz, and 192 kHz. As described above, each bank select register 43₀, 43₁, 43₂ is associated with a corresponding coefficient bank 55₀, 55₁, 55₂, respectively. A sample data rate (value of sampling frequency fₛ) is associated with a given bank 55ₖ by setting the bit position associated with that sample data rate in its corresponding bank select register 43ₖ. For example, if coefficient bank 55₀ is to be associated only with a sample data rate of 44.1 kHz, the third most significant bit of bank select register 43₀ will be set (e.g., to a “1” state) and the other bits of bank select register 43ₒ will be cleared.

Alternatively, if no bank select association values are provided by system microcontroller 30, default values are stored in bank select registers 43. An example of a default setting is to place set all bits in bank select register 43₀, and clear all bits in bank select registers 43₁, 43₂. This will cause digital audio PWM processor 20 to use coefficient bank 55₀ for all values of sampling frequency fₛ. Further in the alternative, or in addition, simple logic circuitry can effect the writing of default bit states into third bank select register 43₂ in response to the writing of any association data in either of bank select registers 43₀ or 43₁, for example by exclusive-OR of the states of the corresponding bits of bank select registers 43₀ or 43₁ (so that a “0” in the same bit position of bank select registers 43₀ or 43₁ forces a “1” state in that bit position of bank select register 43₂. This ensures that each of the available sample rates will have a coefficient bank 55 associated therewith. Other implementations that link coefficient banks 55 with one or more sample rates may alternatively be employed, as desired.

According to the preferred embodiment of the invention, digital audio PWM processor 20 can operate in a manual coefficient value bank selection mode, or in an automatic mode. System microcontroller 30 controls this selection in process 66, by writing a control sword to bank control register 41 in controller 40, again over control channel CTRL_CH. FIG. 6b illustrates an exemplary construction of bank control register 41, in which three bits M are dedicated to receiving a digital value indicative of the desired manual or automatic bank switching mode, according to this invention. In this specific implementation, automatic mode is selected by writing a digital value of 011₂in the three M bits of bank control register 41, while the writing of the values 000₂, 001₂, and 010₂ selects the manual operating mode and indicates that coefficient bank 55₀, 55₁, or 55₂, respectively, is selected as the bank of coefficient values to be currently used. Decision 67 is then next executed by controller 40 to determine the result of the writing process 66, by evaluating the value written into the M bits of bank control register 41 as discussed above.

Various arrangements of registers 41, 43 are contemplated. For example, while registers 41, 43 are shown in this description as being separate registers relative to one another, it is also contemplated that bank control register 41 and bank select registers 43 may be combined into one long register. Those skilled in the art having reference to this specification will be able to readily arrange these control registers in a manner optimized for each particular implementation of the invention.

Referring back to FIG. 5, if manual operating mode is selected (decision 67 is MANUAL), process 68 is next executed, by way of which the contents of the selected coefficient bank 55₀, 55₁, or 55₂ (indicated by the contents of the M bits of bank control register 41, as discussed above) are applied to digital audio processor 20d for use in its digital signal processing channels 44. As mentioned above, digital audio processor 20d may be realized as a DSP core, in which case process 68 may be performed by the writing of the contents of the selected coefficient bank 55₀, 55₁, or 55₂ to the data memory or register bank of that DSP core. Alternatively, a pointer may be set, in process 68, so that coefficient fetch operations executed by the DSP core are directed to the currently selected coefficient bank 55₀, 55₁, or 55₂. The particular manner in which process 68 is realized of course depends on the construction and architecture of digital audio processor 20d.

On the other hand, if the automatic mode is selected (decision 67 is AUTO), then the selection of the appropriate one of coefficient bank 55₀, 55₁, or 55₂ is based on the operation of sample rate detector 54. In process 70, sample rate detector 70 measures the sampling frequency fₛ that is indicated by sample clock SCLK, relative to the reference clock based on external crystal XTL. Once the current sample rate is determined in process 70 and communicated to controller 40, process 72 is next performed by controller 40 to determine the correct one of coefficient banks 55₀ through 55₂. According to the preferred embodiment of the invention, process 72 is performed by scanning the corresponding bit position of rate select registers 43₀ through 43₂ in sequence, to determine the first register 43 that has its bit associated with the detected sample rate set. For example, rate select register 43₀ may first be interrogated, and if the bit position for the detected sample rate is not set, then rate select register 43₁ is then interrogated. The sequential scanning of rate select registers 43 enables the use of a default value of all “1” bits, preferably in the first rate select register 43₁, to ensure that an association exists for each sample rate, thus avoiding initialization errors. Upon controller 40 finding a match for the detected sample rate, process 74 is then performed to apply the coefficient values in the selected coefficient bank 55₀, 55₁, or 55₂to digital audio processor 20d as described above.

After this initialization, digital audio PWM processor 20 begins performing its desired digital audio signal processing of audio signals, including the applying of digital filters and other functions to each channel of digital audio, using the coefficient values in the selected coefficient bank 55₀ through 55₂ for the current sampling frequency.

During the operation of digital audio PWM processor 20, it is contemplated that system controller 30 or another source may wish to update one or more of the coefficient values in coefficient banks 55₀ through 55₂. This updating is permitted, according to the preferred embodiment of the invention, in both the manual and automatic mode. According to a preferred embodiment of this invention, the updated coefficient value may be written by system controller 30 over control channel CTRL_CH by forwarding a control word corresponding to bank control register 41, but with the digital values 100₂, 101₂, 110₂ in the M bits indicating an update to coefficient bank 55₀, 55₁, or 55₂, respectively. The updated coefficient values can then be forwarded. Updating of the coefficient banks 55 without switching banks in manual mode, and without vulnerability to data corruption from a clock error or data rate change in automatic mode, is therefore readily accomplished.

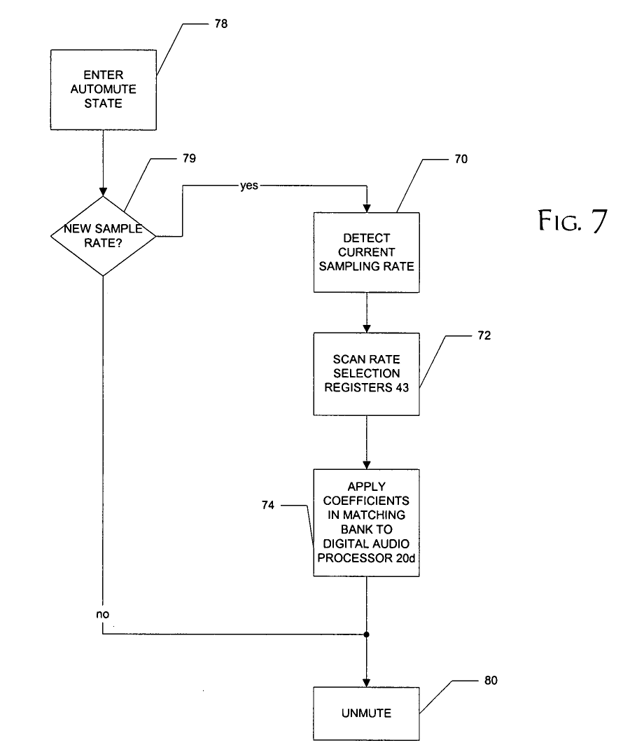

Referring now to FIG. 7, the operation of digital audio PWM processor 20 in effecting a sample rate change will now be described, for the case of automatic sample rate detection being enabled. According to this embodiment of the invention, this bank switch process is preferably performed with digital audio PWM processor 20 in a mute condition, to prevent audible clicks and pops due to substantially instantaneous changes in digital audio PWM processor 20 from occurring. As known in the art, changes in audio source or other operational conditions are typically interpreted by digital audio receiver 21 as, among other things, a command to enter an automute condition for a brief period, during which the operational state of receiver 21 can change to the new input or other new state, without generating audible noise or other artifacts. If digital audio PWM processor 20 is configured so that the PWM frame rate depends upon the sampling frequency fₛ, sampling frequency fₛ can also change with changes in the AM frequency to which tuner 16 is tuned. In either case, the automute state of digital audio PWM processor 20 is entered, in process 78 shown in FIG. 7.

In decision 79, controller 40 and sample rate detector 54 determine whether a new sample rate of sample clock SCLK is being received, relative to the previous sample rate. If a new sample rate is not detected (decision 79 is NO), then the association of the current coefficient bank 55₀, 55₁, or 55₂ has not changed, and digital audio can then again be produced after unmuting process 80.

However, if a new sample rate is detected (decision 79 is YES), either by the automatic detection by sample rate detector 54 or by a manual switching of the sample rate by a control word over control channel CTRL_CH, then processes 70 through 74 (FIG. 5) are then repeated for the new sample rate, respectively. As before, the new sample rate is detected in process 70, in response to which, in process 72, controller 40 determines the one of coefficient banks 55₀ through 55₂ to be associated with the new sample rate. Because coefficient banks 55₀ through 55₂ are located in close proximity to, and in the same integrated circuit as, digital signal processing channels 44i, the coefficient values are immediately available, and need not be downloaded from a system microcontroller or elsewhere into digital audio processor 20d. Rather, process 74 simply applies the values from the matching coefficient bank 55 to digital audio processor 20d. Upon completion of this association process 74, digital audio processor 20d unmutes, in process 80. The new coefficient values for the new sample rate are then ready for processing of live signals.

This invention therefore provides important advantages over conventional digital audio processors. Changes in the sampling frequency of the incoming digital audio datastream can now be easily handled, according to this invention, by permitting a simple switch of coefficient banks within the digital audio processor circuit. Downloading of a large number of coefficient values for a different sampling frequency, through a relatively slow data interface such as control channel CTRL_CH, is no longer necessary, as in conventional systems. In addition, the automatic detection of the sampling frequency of the input datastream permits the transparent and automatic selection of the appropriate coefficient values without user or system controller intervention.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A digital audio processor, comprising:
digital signal processing circuitry for applying at least a first digital filter to digital signals corresponding to a first audio channel and having a sampling frequency;
control circuitry, coupled to the digital signal processing circuitry, for controlling the operation of the digital signal processing circuitry, and comprising:
a plurality of coefficient memory banks, each for storing coefficient values for the first digital filter corresponding to one of a plurality of sampling frequencies;
an interface for receiving coefficient values to be stored in the plurality of coefficient memory banks from external to the digital audio processor; and
circuitry for selecting one of the plurality of coefficient memory banks for use by the digital signal processing circuitry, the selected one of the plurality of coefficient memory banks storing coefficient values corresponding to the sampling frequency.

2. The processor of claim 1, wherein the selecting circuitry comprises:
a plurality of rate select registers, each associated with one of the plurality of coefficient memory banks, for indicating sampling frequencies corresponding to which its associated coefficient memory bank is to be selected.

3. The processor of claim 2, wherein each of the plurality of coefficient memory banks can be associated with one or more of a plurality of sampling frequencies;
and wherein each of the rate select registers comprises a plurality of entries, each entry associated with one of the plurality of sampling frequencies and for storing an indicator of whether its associated coefficient memory bank is to be associated with its associated one of the plurality of sampling frequencies.

4. The processor of claim 2, wherein the selecting circuitry further comprises:
a sample rate detector, for detecting the sampling frequency of the digital signals; and
wherein the selecting circuitry is for selecting a coefficient memory bank corresponding to the detected sampling frequency.

5. The processor of claim 1, wherein the selecting circuitry comprises:
a bank control register for storing an entry indicating the selected one of the plurality of coefficient memory banks.

6. The processor of claim 5, wherein the interface is also for receiving the entry indicating the selected one of the plurality of coefficient memory banks.

7. The processor of claim 6, wherein the selecting circuitry further comprises:
a sample rate detector, for detecting the sampling frequency of the digital signals; and
a plurality of rate select registers, each associated with one of the plurality of coefficient memory banks, for indicating sampling frequencies corresponding to which its associated coefficient memory bank is to be selected;
wherein the selecting circuitry is for selecting a coefficient memory bank corresponding to the detected sampling frequency, responsive to an entry in the bank control register indicating an automatic operating mode.

8. The processor of claim 1, wherein the digital signal processing circuitry is for applying at least a first digital filter to digital signals corresponding to a plurality of audio channels and having the sampling frequency.

9. The processor of claim 1, wherein the digital signals correspond to digital audio signals;
and wherein the digital signal processing circuitry comprises circuitry for applying a plurality of digital filters to the digital signals, the plurality of digital filters including a plurality of biquad digital filters.

10. The processor of claim 1, wherein the digital signals correspond to digital audio signals;
and further comprising:
pulse width modulation circuitry, for generating pulse-width-modulated signals corresponding to digital signals processed by the digital signal processing circuitry.

11. The processor of claim 1, wherein the digital signal processing circuitry comprises a digital signal processor core.

12. A method of digital audio signal processing, comprising the steps of:
storing digital filter coefficient values corresponding to at least one of a plurality of sampling frequencies, in one of a plurality of coefficient memory banks of a digital audio processor;
receiving a datastream at a sampling frequency, the datastream comprising digital audio signals for a first audio channel;
selecting one of a plurality of coefficient memory banks corresponding to the sampling frequency of the datastream; and
operating the digital audio processor to apply at least one digital filter to the received datastream using coefficient values from the selected coefficient memory bank.

13. The method of claim 12, wherein the selecting step comprises:
storing an entry in a bank control register of the digital audio processor to indicate the selected one of the plurality of coefficient memory banks.

14. The method of claim 12, wherein the selecting step comprises:
detecting the sampling frequency of the received datastream; and
identifying the one of the plurality of coefficient memory banks corresponding to the detected sampling frequency.

15. The method of claim 14, wherein the digital audio processor comprises a plurality of rate select registers, each associated with one of the plurality of coefficient memory banks;
and further comprising:
storing entries in one or more of the rate select registers to indicate one or more sampling frequencies with which its associated coefficient memory bank is to be selected;
and wherein the selecting step further comprises:
scanning the plurality of rate select registers to identify which of the plurality of coefficient memory banks is to be selected for the detected sampling frequency.

16. The method of claim 14, further comprising:
prior to the selecting step, setting an automatic mode entry in a bank control register of the digital audio processor;
wherein the detecting and identifying steps are performed responsive to the bank control register set with the automatic mode entry.

17. The method of claim 16, wherein the selecting step comprises:
storing an entry in the bank control register of the digital audio processor indicating the selected one of the plurality of coefficient memory banks; and
inhibiting the detecting and identifying steps, responsive to the step of storing an entry indicating the selected one of the plurality of coefficient memory banks.

18. The method of claim 16, further comprising:
placing the digital audio processor in a mute state;
detecting a new sampling frequency for the datastream;
identifying the one of the plurality of coefficient memory banks corresponding to the new detected sampling frequency; and
placing the digital audio processor in an unmute state.

19. The method of claim 16, further comprising:
addressing one of the plurality of coefficient memory banks by writing an entry in the bank control register; and
storing an updated coefficient value in the addressed one of the plurality of coefficient memory banks.
